(19) United States
(12) Patent Application Publication
(10) Pub. No.: US 2011/0273810 A1
(43) Pub. Date: Nov. 10, 2011

(54) SURGE ARRESTER

(75) Inventor: Shang-Yo Lee, Taipel (TW)

(73) Assignee: FIRST RESISTOR & CONDENSER CO., LTD., TAIPEI (TW)

(21) Appl. No.: 13/145,272

(22) PCT Filed: Jan. 21, 2010
(86) PCT No.: PCT/CN10/00099

§ 371 Date: Jul. 19, 2011

(30) Foreign Application Priority Data
Jan. 23, 2009 (TW) 099101728

(51) Int. Cl. H01C 7/12

(52) U.S. Cl. 361/118

(57) ABSTRACT

A surge arrester, comprising: a resistor body, including a ceramic core and a conductive film, the conductive film being deposited to enclose the ceramic core entirely; two caps, each enclosing one end of the resistor body; an opening, being cut in the middle part of the resistor body to separate the surface of the resistor body into two portions; a porous layer, filled in the opening; and an insulating layer, being coated to protect the porous layer, and the resister body.

### FIELD OF INVENTION

The present invention relates generally to a surge arrester, particularly to a surge arrester using a resistor body for overvoltage protection of an electronic device.

### BACKGROUND OF THE INVENTION

A surge arrester is a protective device designed primarily for connection in parallel with an electronic device to bypass a transient overvoltage when occurring in the electronic device, thereby protecting the electronic device from being damaged due to a sudden overvoltage applied thereon.

As shown in FIG. 1, a conventional surge arrester (10) comprises a resistor body (11), including a ceramic core (111) and a conductive film (112), the conductive film being deposited on the ceramic core entirely; two caps (13); an opening (14); a glass tube (15), sealing the resistor body, caps and opening; and neon gas, being filled inside the glass tube. The conventional surge arrester further provides two leads (161 and 162), each attaching to one of two ends of the glass tube and one of two discs (171 and 172), sealing the above elements. Such a conventional surge arrester is complex in construction and difficult in production, requires the same expansion coefficient for the glass tube and the two discs, and it thus is impractical in use.

The industry thus needs an improved surge arrester which contains a simplified construction and has superior performance for absorbing transient voltages.

### SUMMARY OF THE INVENTION

The present invention relates to a surge arrester, comprising: a resistor body, including a ceramic core and a conductive film, the conductive film being deposited to enclose the ceramic core entirely; two caps, each enclosing one end of the resistor body; an opening, being cut in the middle part of the resistor body to separate the surface of the resistor body into two portions; a porous layer, filled in the opening; and an insulating layer, coated to protect the porous layer, the opening and the resister body.

### BRIEF DESCRIPTION OF THE DRAWINGS

FIG. 1 shows the structure of a conventional surge arrester.

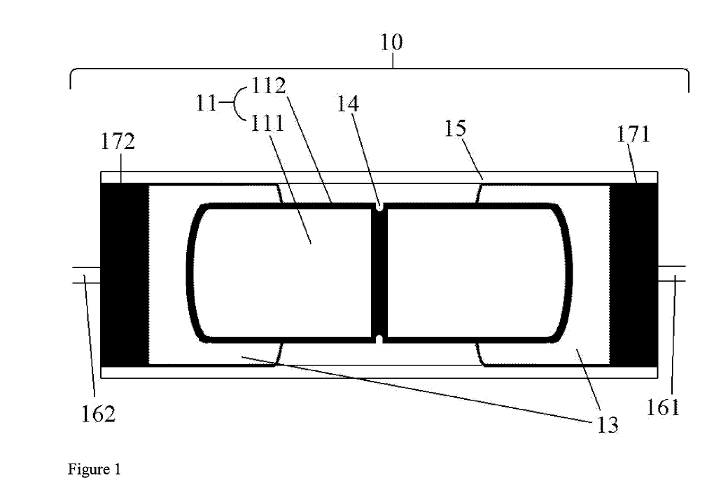

FIG. 2 shows the structure of a preferred embodiment of a surge arrester according to the invention (without a lead).

FIG. 3 shows the structure of a preferred embodiment of a surge arrester according to the invention (with a lead).

### DETAILED DESCRIPTION OF THE INVENTION

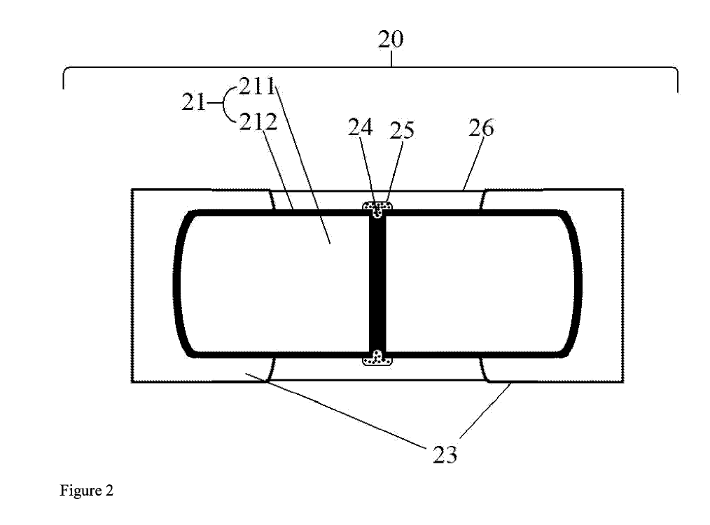

As shown in FIG. 2, in a preferred embodiment of the invention, a surge arrester (20) comprises a resistor body (21), including a ceramic core (211) and a conductive film (212) of a metal film, a carbon film, a metal oxide film, or a metal glaze film, the conductive film being deposited to enclose the ceramic core entirely; two caps (23), each enclosing one end of the resistor body; an opening (24), being cut in the middle part of the resistor body to separate the surface of the resistor body into two portions; a porous layer (25), filled with ceramic particles, such as quartz sand, in the opening; and an insulating layer (26) of an epoxy resin, coated to enclose the porous layer and the resister body except the two caps. Such a preferred embodiment is provided for being installed in a SMT (Surface-Mounted Technology) manner.

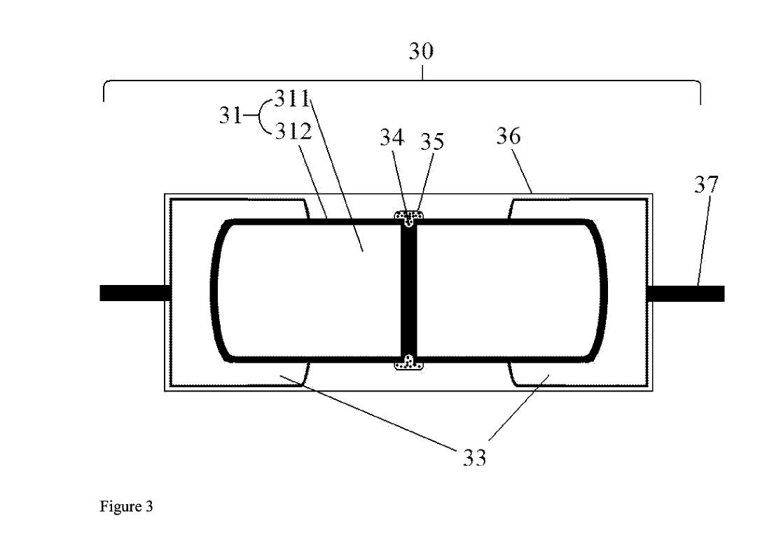

As shown in FIG. 3, a surge arrester (30) comprises a resistor body (31), including a ceramic core (311) and a conductive film (312) of a metal film, a carbon film, a metal oxide film, or a metal glaze film, the conductive film being deposited to enclose the ceramic core entirely; two caps (33), each enclosing one end of the resistor body; an opening (34), being cut in the middle part of the resistor body to separate the surface of the resistor body into two portions; a porous layer (35), filled with ceramic particles, such as quartz sand, in the opening; and an insulating layer (36) of an epoxy resin, coated to enclose the porous layer, the resister body and the two caps (33). Each of leads (371 and 372) is provided on each of the caps (33), and the insulating layer (36) is coated to further enclose the caps.

The transient voltage to be absorbed by the surge arrester of the invention may be 200 volts, 1000 volts or even higher. The different specifications of switch-on voltage of the surge arrester of the invention may be achieved by adjusting the width of the opening and the density of the ceramic particles. When switched on, the sparks travel in the voids of the porous layer, not being hindered by the insulating layer.

With the invention, it is easy to produce the surge arrester of the invention using a production procedure similar to fabricating a traditional resistor. If an electronic device to be protected is easily subject to a transient voltage of 200 volts or 1000 volts or higher, the surge arrester of the invention will bypass such an overvoltage in an efficient and reliable way, thereby protecting the electronic device in a safe manner.

1. A surge arrester, comprising: a resistor body, including a ceramic core and a conductive film, the conductive film being deposited to enclose the ceramic core entirely; two caps, each enclosing one end of the resistor body; an opening, being cut in the middle part of the resistor body to separate the surface of the resistor body into two portions; a porous layer, filled in the opening; and an insulating layer, coated to protect the porous layer and the resister body.

2. A surge arrester as claimed in claim 1, wherein the conductive film is a metal film, a carbon film, a metal oxide film, or a metal glaze film.

3. A surge arrester as claimed in claim 1, wherein the porous layer is filled with ceramic particles.

4. A surge arrester as claimed in claim 1, wherein the insulating layer is made of epoxy resin.

5. A surge arrester as claimed in claim 1, wherein the insulating layer is coated to entirely enclose the caps if a lead is provided on each of the caps.

6. A surge arrester as claimed in claim 3, wherein the ceramic particles are quartz sand.
